(19) United States
(12) Patent Application Publication
(10) Pub. No.: US 2026/0312960 A1
(43) Pub. Date: Oct. 8, 2026

(54) SYSTEM AND METHOD OF CONTROLLING CREDENTIAL SHARING OF RESOURCES TECHNICAL FIELD

(71) Applicant: THALES DIS CPL USA, INC., Austin, TX (US)

(72) Inventors: Peter YuBao CHENG, Beijing (CN); Hao ZHAO, Beijing (CN)

(73) Assignee: THALES DIS CPL USA, INC., Austin, TX (US)

(21) Appl. No.: 19/482,276

(22) PCT Filed: May 14, 2024
(86) PCT No.: PCT/US2024/029251

§ 371 Date: Nov. 7, 2025

(30) Foreign Application Priority Data
May 15, 2023 (CN) 202310544612.6

(51) Int. Cl. H04L 9/40

(52) U.S. Cl. CPC H04L 63/108; H04L 63/0876; H04L 63/102

(57) ABSTRACT

A system or method for controlling a frequency of credential sharing of resources on a computer network can include tracking a machine status change event for one or more of a plurality of machines on the computer network, controlling a frequency of the machine status change event by designating a blocking date upon the machine status change event, where a subsequent machine status change event is only allowed to occur or recognized after the blocking date, and updating the blocking date with a progressively increasing interval waiting period for each subsequent machine status change event to discourage and make the subsequent machine status change events progressively more difficult.

The present invention relates generally to identity and access management, and more particularly, to system and method of controlling a frequency of credential sharing of resources.

### BACKGROUND

Remote access systems enable users to remotely access resources hosted on remote systems and share credentials. Credential sharing, the practice of using someone else's digital identity to gain access to a platform or product, has become commonplace, particularly when it comes to video streaming services. While credential sharing brings with it obvious user-end security issues for organizations of all sizes in all verticals, it also poses a serious problem for organizations that depend on the revenue generated from paid user accounts on a per user basis.

Usually there are some technologies to discourage or prevent credentials sharing such as single-sign-on technology, multi-factor authentication, blocking of simultaneous logins, and limiting access to authorized fingerprinted client devices. Here is a quick review of such methods or technologies.

Single-Sign-On Technology makes the login process more convenient for users (who need to remember one less username and password combination) and discourages credential sharing. People don't want their friends and co-workers poking around on their personal social media accounts, which are chocked full of sensitive personal information and, in the case of Google, credit card access in the form of Google Pay. Thus, users using single-sign-on are less likely to share their logins.

Multi-factor or at least Two-Factor Authentication will typically pair a strong password with at least a second factor such as a text message or code sent to a pre-registered phone number or a hardware element. Such hardware element will typically only be in the appropriate user's hands and not shared with a friend or second user. Time limiting the validity of the code will limit sharing, but again, this technique is not foolproof.

Some technologies can block simultaneous logins. If an application service is stateful, it can check session information. On the other hand, if it is stateless, it can monitor for a single unique IP address.

Some technologies can limit access to specific machines. Usually, an application service will collect a client fingerprint, and then only an authorized fingerprint can be configured to access such application service resource

Accordingly, a need for a more practical credential sharing technology is contemplated that addresses the needs of the user and the developers of the application. All of the subject matter discussed in this Background section is not necessarily prior art and should not be assumed to be prior art merely as a result of its discussion in the Background section. Along these lines, any recognition of problems in the prior art discussed in the Background section or associated with such subject matter should not be treated as prior art unless expressly stated to be prior art. Instead, the discussion of any subject matter in the Background section should be treated as part of the inventor's approach to the particular problem, which, in and of itself, may also be inventive.

### SUMMARY

In some embodiments, a system for controlling a frequency of credential sharing of resources on a computer network can include one or more processors and memory coupled to the one or more processors configured to perform the operations of tracking a machine status change event for one or more of a plurality of machines on the computer network, controlling a frequency of the machine status change event by designating a blocking date upon the machine status change event, wherein a subsequent machine status change event is only allowed to occur or recognized after the blocking date, and updating the blocking date with a progressively increasing interval waiting period for each subsequent machine status change event to discourage and make the subsequent machine status change events progressively more difficult.

In some embodiments, the machine status change event can include one operation among enable, disable, or delete.

In some embodiments, the progressively increasing interval waiting period follows a Fibonacci sequence. In other embodiments, the progressively increasing interval waiting period is a sequence that increases by at least 1 in at least every other interval.

In some embodiments, the one or more of the plurality of machines on the network each have a registered machine fingerprint which is registered to an identity upon an initial login by a user associated with the identity.

In some embodiments, one or more processors further perform the operation of providing a credential having attributes of expiration, a maximum of registered machines, and of an identity. In some embodiments, the one or more processors further perform the operation of controlling a maximum number of registered machines that can be used by the identity by setting a value to the maximum of registered machines. In some embodiments, the one or more processors further perform the operation of creating a machine fingerprint for each client machine associated with the identity, wherein the machine fingerprint is registered to the identity at a first login time for the identity. In some embodiments, the one or more processors further perform the operation of creating a machine fingerprint as a hashed value for each client machine associated with the identity, wherein the machine fingerprint is registered to the identity at a first login time for the identity. In some embodiments, the one or more processors further perform the operation of using the blocking date as a time control for each client machine associated with the identity, wherein the blocking date is updated for a client machine upon the subsequent machine status change event for the client machine. In some embodiments, the one or more processors further perform the operation of creating a last known waiting period variable that controls a speed of changes to the blocking date.

In some embodiments, the system implements a table of machine waiting period that tracks the (user) identity, the machine fingerprint associated with the identity, and the blocking date for machine fingerprint. In some embodiments, the system further maintains a user table having values for the identity, a credential for the identity, a last known waiting period for each credential, and a maximum registered machine for each identity, where one user can map to many credentials and one credential can map with many machines.

In some embodiments, the one or more processors further perform the operation of creating a time lock that prevents simultaneous access to a resource by other machines belonging to a same credential until the time lock is freed.

In some embodiments, a system for controlling a frequency of credential sharing of resources on a computer network can include one or more processors and memory coupled to the one or more processors, where the memory includes computer instructions which when executed by the one or more processors causes the one or more processors to perform the operations of tracking a machine status change event for one or more of a plurality of machines on the computer network, providing a credential having attributes of expiration, a maximum of registered machines, and of an identity, controlling a maximum number of registered machines than can be used by the identity by setting a value to the maximum of registered machines, and creating a machine fingerprint for each client machine associated with the identity, wherein the machine fingerprint is registered to the identity at a first login time for the identity. The one or more processors can further perform the functions of creating a blocking date that serves as a time control for each client machine associated with the identity, wherein the blocking date is updated for each machine upon a machine status change event and creating a last known waiting period variable that controls a rate of change to the blocking date.

In some embodiments, the machine status change event comprises one operation among enable, disable, or delete.

In some embodiments, the one or more processors are configured to update the blocking date with a progressively increasing interval waiting period for each subsequent machine status change event to discourage and make the subsequent machine status change events progressively more difficult and wherein the progressively increasing interval waiting period follows a Fibonacci sequence.

In some embodiments, the system implements a table of machine waiting period that tracks the (user) identity, the machine fingerprint associated with the identity, and the blocking date for machine fingerprint. In some embodiments, the system further maintains a user table having values for the identity, a credential for the identity, a last known waiting period for each credential, and a maximum registered machine for each identity, where one user can map to many credentials and one credential can map with many machines.

In some embodiments, a method for controlling a frequency of credential sharing of resources on a computer network can include one or more processors and memory coupled to the one or more processors, wherein the memory includes computer instructions which when executed by the one or more processors causes the one or more processors to perform the operations of tracking a machine status change event for one or more of a plurality of machines on the computer network, controlling a frequency of the machine status change event by designating a blocking date upon the machine status change event, wherein a subsequent machine status change event is only allowed to occur or recognized after the blocking date, and updating the blocking date with a progressively increasing interval waiting period for each subsequent machine status change event to discourage and make the subsequent machine status change events progressively more difficult.

In some embodiments, the method further performs the operation of controlling a maximum number of registered machines that can be used by the identity by setting a value to the maximum of registered machines, creating a machine fingerprint for each client machine associated with the identity, where the machine fingerprint is registered to the identity at a first login time for the identity, using the blocking date as a time control for each client machine associated with the identity, where the blocking date is updated for a client machine upon the subsequent machine status change event for the client machine.

### BRIEF DESCRIPTION OF THE DRAWINGS

The accompanying drawings, which are incorporated in and constitute a part of this description, illustrate embodiments consistent with the invention and, together with the description, serve to explain the principles of the invention.

FIG. 1 illustrates a system for controlling a frequency of credential sharing of resources on a computer network where the ID owner only has a single seat in accordance with an embodiment;

FIG. 2 depicts a machine waiting period table in accordance with one embodiment;

FIG. 3 depicts a user table in accordance with an embodiments;

FIG. 4 depicts another system for controlling a frequency of credential sharing of resources on a computer network where the ID owner has at least two seats in accordance with an embodiment; and

FIG. 5. is a flow chart illustrating a method for controlling a frequency of credential sharing of resources on a computer network in accordance with an embodiment.

Specific embodiments herein have been shown by way of example in the foregoing drawings and are hereinafter described in detail. The figures and written description are not intended to limit the scope of the inventive concepts in any manner. Rather, they are provided to illustrate the concepts to a person skilled in the art by reference to particular embodiments.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims.

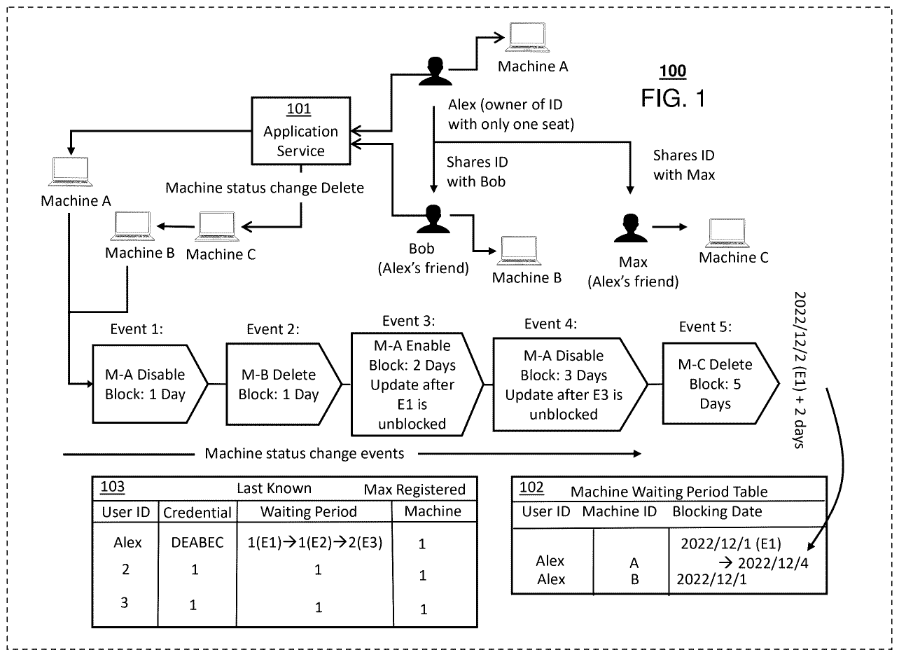

FIG. 1 illustrates a system 100 that utilizes an application service 101 to change a machine status among a plurality of client devices or machines (Machine A, Machine B, Machine C, etc.). In this scenario, the owner of the identity or credential (Alex) shares his ID with his friends Bob and Max

The Identity/Credential is used by the end user to access the application service. The application service can provide access to resources such as applications and/or streaming services. In some embodiments, the system 100 can use several tables to effectuate a desired result. For example, it can use a Machine Waiting Period table 102 and a User table 103 as shown in FIG. 1. The tables can contain some attributes like an expiration or blocking date, MaxRegisteredMachine, and owner of the identity.

MaxRegisteredMachine is a parameter to control of a maximum number of machines for a user. It is defined in an identity attribute. It controls how many machines can be registered for each identity.

A MachineFingerprint can be a set of hashed value(s) of a client machine's hardware related feature. It can be registered to identity/credential at the first login time for the authorized user.

Blocking date is a time control which can be updated for each machine status change. Before this blocking date, the machine status cannot be changed again. In some embodiments, the blocking date will progressively get larger (or longer) for each machine status change. Thus, making it more difficult to frequently share credentials.

LastKnownWaitingPeriod controls the increasing speed of the blocking date.

In the scenario of FIG. 1, it is assumed that Alex has only one machine, and that he creates an account on an application service. After login, this machine's fingerprint will be auto-registered into the application service.

It is a normal requirement that the application service will supply a way to help Alex migrate his identity from one machine to another machine because it is likely and natural that he may purchase a new machine to replace an old one. In another scenario, such as in urgent or emergency cases, Alex may want to use another machine to use it temporally. Usually, the application service will supply an option to enable/disable/delete the current machine.

The challenge as an application service vendor, is to provide such flexibility while also preventing credential sharing with non-authorized users. Some users may use this option to achieve identity/credential sharing. The embodiments herein are designed to provide a method or methods to satisfy above requirements.

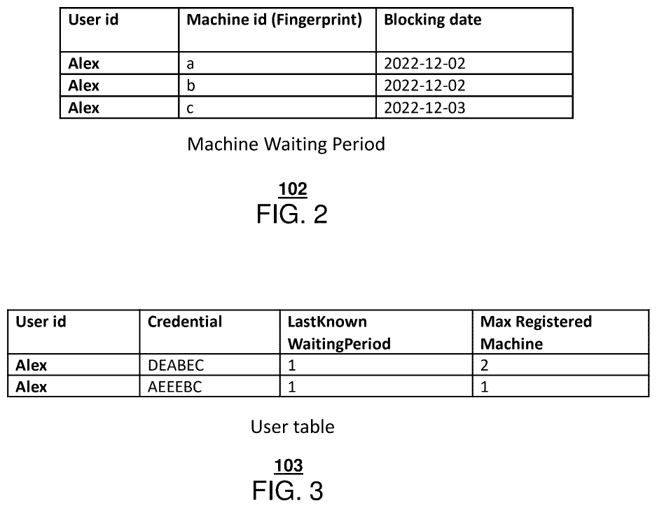

In accordance with some embodiments, an Application service 101 can implement as shown in FIG. 2 a table 102 of machine waiting period where:
1. One user can own many machines (e.g., Alex has machine IDs a, b c).
2. Once the user requires a machine status change like enable/disable/delete, the corresponding Blocking Date of this event will be updated into the Table 102 shown below in FIG. 2.

Each account maintains a user table 103 as shown in FIG. 3.
1. The machine with Machine id (Fingerprint) in Table 102 can be registered to the Credential in Table 103.
2. The system in Table 103 defines a LastKnownWaitingPeriod for each credential, which is following a certain increasing sequence pattern, eg. 1, 2, 3, 4, 5, or a Fibonacci sequence pattern such as 1, 1, 2, 3, 5, 8, etc. The initial expiration is 1 day.
3. Once the user accesses some resource, eg. resource 1 from some machine, e.g. Machine b, with the credential DEABEC., the User needs to TimeLock for DEABEC, to access resource 1. The time lock is only used when MaxRegisteredMachine>1.

One user can map to many Credentials, and one credential can combine with many machines.

When the Blocking date in Table 102 is not expired, it means the machine status cannot change. As a result, you cannot use the Credential in Table 103 for a new machine.

If the Blocking Date in Table 102 is expired, user can then change the machine status again, and the new Blocking date will be updated into the machine waiting period table. The new Blocking Date=current date+LastKnownWaitingPeriod in Table 103. Because the LastKnownWaitingPeriod is increasing, it becomes more and more difficult to change machine status if machine status change happens as time goes on.

In some embodiments, the user needs a TimeLock to access some resource. The Timelock means that other machines belonging to the same credential can't access a resource until the time lock is freed.

FIG. 1 illustrates how to loan or share the identity to a friend's machine temporally. In FIG. 1, Alex will get a credential when the account is created. In the User table 103, a new item for Alex is added showing that Alex owns the Credentials DEABEC. After login, his machine will be auto-registered into the application service. The MaxRegisteredMachine for Alex is 1. Alex tries to loan his identity to Bob.

For Event 1 (E1): Alex disables Machine A, in the machine waiting period table 102, a new item is added for Alex, machine A, assuming the Blocking date for E1 is 2022-12-01. Using the Fibonacci sequence in this case, so the LastKnownWaitingPeriod turns to the second ‘1’in the sequence in User table 103.

For Event 2 (E2): After Bob finishes using Alex's identity, he disables machine B. In Table 102, a new item is added for Alex machine B, assuming the blocking date is also 2022-12-01 for E2. The LastKnownWaitingPeriod turns to 2.

For Event 3 (E3): Alex enables Machine A again. Machine A's status can only be updated when event 1 is expired, means Alex can enable Machine A on 2022-12-02, and by adding the 2 days LastKnownWaitingPeriod in table 103, we get the new blocking date for Machine A is 2022-12-02+2 days=2022-12-04.

Now if Alex tries to disable Machine A again to share this identity with Max, he needs to wait until Event 3 is expired. In this way, the identity is more and more difficult to share.

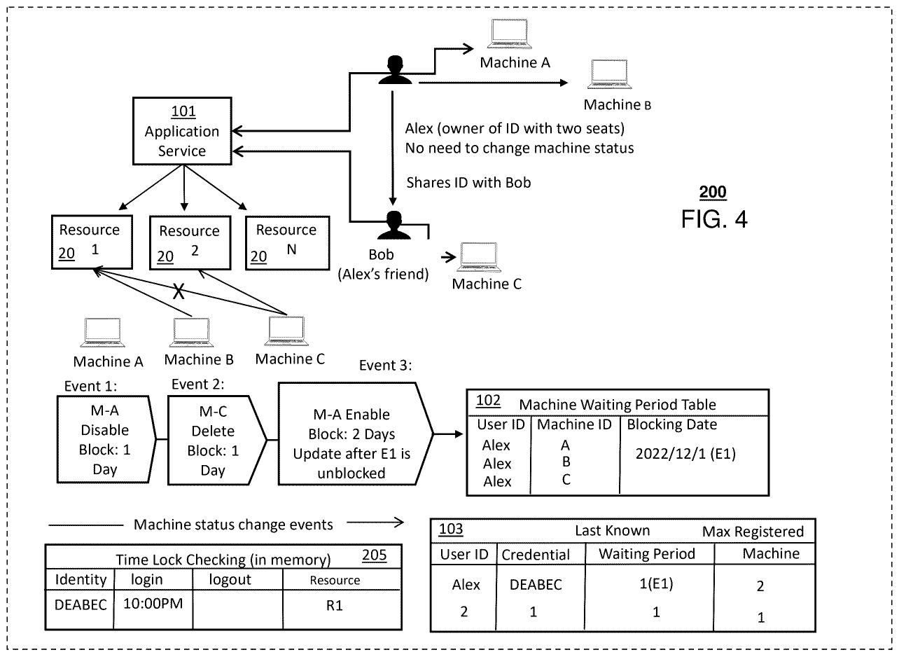

FIG. 4 illustrates a system the user has one credential, but two authorized seats. In other words, the system assumes Alex has two machines, and he creates an account on an application service. His identity has two seats, the MaxRegisteredMachines is equal to 2, then he doesn't need to change machine status to enable both machines to have access to the application service. TimeLock (see Table 105) avoids two different machines which are registered to the same credential to access the same resource simultaneously. Alex tries to share his identity with Bob again.

Event 1 (E1): Alex disables Machine A. He still can use Machine B to watch the resource 1 on the application service. When Alex uses the DEABEC identity to login to Resource 1, we add a new item in the Time lock checking list 205, record which identity accesses which resource, and the login and logout time. In this example, Machine B is login but not logout. So Bob cannot use Machine C to login to Resource 1 now. Bob needs to wait until the Machine B logout to free the identity.

The embodiments control the frequency of identity/credential sharing by effectively limiting the frequency of the user to change their MachineStatus (disable/delete/enable). In this regard, the embodiments can track the events of machine status change. When the machine status is changed, the machine will get a new Blocking Date. Before this blocking date, the status of the machine cannot be changed again. In accordance with some embodiments, the Blocking Date will increase after each (or at least every other) event of machine status change. The system is design to become more and more difficult to change machine status if machine status change repeats frequently. Identity sharing will become more difficult as time goes on. Further, each identity can be assigned with a Time Lock to access a resource when login happens. Time lock will be freed only after logout. The same resource cannot be accessed by different machines belong to the same identity simultaneously.

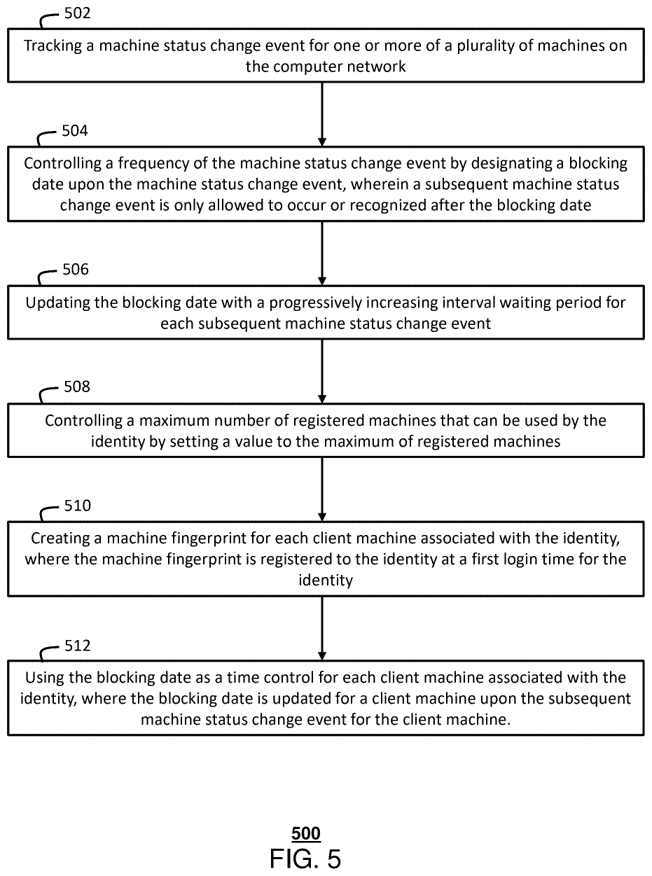

FIG. 5 depicts a method 500 for controlling a frequency of credential sharing of resources on a computer network such as those shown in FIGS. 1 and 4. The method can be implemented using one or more processors and memory coupled to the one or more processors where the memory includes computer instructions which when executed by the causes the one or more processors to perform the method 500. The method 500 can include the operations of tracking at 502 a machine status change event for one or more of a plurality of machines on the computer network, controlling at 504 a frequency of the machine status change events by designating a blocking date upon the machine status change event where a subsequent machine status change event is only allowed to occur or recognized after the blocking date, and updating at 506 the blocking date with a progressively increasing interval waiting period for each subsequent machine status change event to discourage and make the subsequent machine status change events progressively more difficult.

In some embodiments, the method 500 further performs the operation of controlling at 508 a maximum number of registered machines that can be used by the identity by setting a value to the maximum of registered machines, creating at 510 a machine fingerprint for each client machine associated with the identity (where the machine fingerprint is registered to the identity at a first login time for the identity), and using at 512 the blocking date as a time control for each client machine associated with the identity, where the blocking date is updated for a client machine upon the subsequent machine status change event for the client machine.

The method 500 may include more or less than the number of steps shown, and may be practiced by components shown in FIG. 1 or 4, but is not limited to only these method steps or those components shown. Reference will be made to the components of FIG. 1 or 4 when describing the method steps, but is not limited to only those components shown.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed, is:

1. A system for controlling a frequency of credential sharing of resources on a computer network, comprising
one or more processors and memory coupled to the one or more processors, wherein the memory includes computer instructions which when executed by the one or more processors causes the one or more processors to perform the operations of:
tracking a machine status change event for one or more of a plurality of machines on the computer network;
controlling a frequency of the machine status change event by designating a blocking date upon the machine status change event, wherein a subsequent machine status change event is only allowed to occur or recognized after the blocking date; and
updating the blocking date with a progressively increasing interval waiting period for each subsequent machine status change event to discourage and make the subsequent machine status change events progressively more difficult.

2. The system of claim 1, wherein the machine status change event comprises one operation among enable, disable, or delete.

3. The system of claim 1, wherein the progressively increasing interval waiting period follows a Fibonacci sequence.

4. The system of claim 1, wherein the one or more of the plurality of machines on the network each have a registered machine fingerprint which is registered to an identity upon an initial login by a user associated with the identity.

5. The system of claim 1, wherein one or more processors further perform the operation of providing a credential having attributes of expiration, a maximum of registered machines, and of an identity.

6. The system of claim 5, wherein one or more processors further perform the operation of controlling a maximum number of registered machines that can be used by the identity by setting a value to the maximum of registered machines.

7. The system of claim 5, wherein one or more processors further perform the operation of creating a machine fingerprint for each client machine associated with the identity, wherein the machine fingerprint is registered to the identity at a first login time for the identity.

8. The system of claim 5, wherein one or more processors further perform the operation of creating a machine fingerprint as a hashed value for each client machine associated with the identity, wherein the machine fingerprint is registered to the identity at a first login time for the identity.

9. The system of claim 5, wherein one or more processors further perform the operation of using the blocking date as a time control for each client machine associated with the identity, wherein the blocking date is updated for a client machine upon the subsequent machine status change event for the client machine.

10. The system of claim 5, wherein one or more processors further perform the operation of creating a last known waiting period variable that controls a speed of changes to the blocking date.

11. The system of claim 1, wherein the system implements a table of machine waiting period that tracks the (user) identity, the machine fingerprint associated with the identity, and the blocking date for machine fingerprint.

12. The system of claim 11, wherein the system further maintains a user table having values for the identity, a credential for the identity, a last known waiting period for each credential, and a maximum registered machine for each identity, where one user can map to many credentials and one credential can map with many machines.

13. The system of claim 1, wherein one or more processors further perform the operation of creating a time lock that prevents simultaneous access to a resource by other machines belonging to a same credential until the time lock is freed.

14. A system for controlling a frequency of credential sharing of resources on a computer network, comprising
one or more processors and memory coupled to the one or more processors, wherein the memory includes computer instructions which when executed by the one or more processors causes the one or more processors to perform the operations of:
tracking a machine status change event for one or more of a plurality of machines on the computer network;
providing a credential having attributes of expiration, a maximum of registered machines, and of an identity;
controlling a maximum number of registered machines than can be used by the identity by setting a value to the maximum of registered machines;
creating a machine fingerprint for each client machine associated with the identity, wherein the machine fingerprint is registered to the identity at a first login time for the identity;
creating a blocking date that serves as a time control for each client machine associated with the identity, wherein the blocking date is updated for each machine upon a machine status change event; and
creating a last known waiting period variable that controls a rate of change to the blocking date.

15. The system of claim 14, wherein the machine status change event comprises one operation among enable, disable, or delete.

16. The system of claim 14, wherein the one or more processors are configured to update the blocking date with a progressively increasing interval waiting period for each subsequent machine status change event to discourage and make the subsequent machine status change events progressively more difficult and wherein the progressively increasing interval waiting period follows a Fibonacci sequence.

17. The system of claim 14, wherein the system implements a table of machine waiting period that tracks the (user) identity, the machine fingerprint associated with the identity, and the blocking date for machine fingerprint.

18. The system of claim 17, wherein the system further maintains a user table having values for the identity, a credential for the identity, a last known waiting period for each credential, and a maximum registered machine for each identity, where one user can map to many credentials and one credential can map with many machines.

19. A method for controlling a frequency of credential sharing of resources on a computer network, comprising one or more processors and memory coupled to the one or more processors, wherein the memory includes computer instructions which when executed by the one or more processors causes the one or more processors to perform the operations of:
tracking a machine status change event for one or more of a plurality of machines on the computer network;
controlling a frequency of the machine status change event by designating a blocking date upon the machine status change event, wherein a subsequent machine status change event is only allowed to occur or recognized after the blocking date; and
updating the blocking date with a progressively increasing interval waiting period for each subsequent machine status change event to discourage and make the subsequent machine status change events progressively more difficult.

20. The method of claim 19, wherein the method further perform the operation of controlling a maximum number of registered machines that can be used by the identity by setting a value to the maximum of registered machines, creating a machine fingerprint for each client machine associated with the identity, wherein the machine fingerprint is registered to the identity at a first login time for the identity, using the blocking date as a time control for each client machine associated with the identity, wherein the blocking date is updated for a client machine upon the subsequent machine status change event for the client machine.
